(19) United States
(12) Patent Application Publication
(10) Pub. No.: US 2024/0318016 A1
(43) Pub. Date: Sep. 26, 2024

(54) Maintenance Liquid And Method Of Maintenance

(71) Applicant: SEIKO EPSON CORPORATION, Tokyo (JP)

(72) Inventors: Keiji IIDA, Chikuhoku (JP); Ippei OKUDA, Shiojiri (JP); Keigo ANDO, Matsumoto (JP)

(21) Appl. No.: 18/612,098

(22) Filed: Mar. 21, 2024

(30) Foreign Application Priority Data
Mar. 22, 2023 (JP) 2023-045305

(51) Int. Cl. C09D 9/00; B41J 2/165

(52) U.S. Cl. CPC C09D 9/005; B41J 2/16552

(57) ABSTRACT

Provided is an aqueous maintenance liquid for use in maintenance of an ink jet recording apparatus ejecting an ink composition. The ink composition is an aqueous ink composition containing a coloring material. The maintenance liquid contains an organic amine and an organic solvent other than the organic amine. The organic solvent contains Polyol A with a normal boiling point of 250° C. or lower. The content of Polyol A is greater than 20.0% by mass with respect to the total amount of the maintenance liquid. The content of the organic amine is 0.3% by mass or more with respect to the total amount of the maintenance liquid. The total content of the organic solvent is less than 30.0% by mass with respect to the total amount of the maintenance liquid. The organic solvent does not contain Polyol B with a normal boiling point of higher than 250° C. in an amount of greater than 1.0% by mass with respect to the total amount of the maintenance liquid.

The present application is based on, and claims priority from JP Application Serial Number 2023-045305, filed Mar. 22, 2023, the disclosure of which is hereby incorporated by reference herein in its entirety.

### BACKGROUND

### 1. Technical Field

The present disclosure relates to a maintenance liquid and a method of maintenance.

### 2. Related Art

The method of ink jet recording can record high-definition images by relatively simple apparatuses and are being rapidly developed in various fields. In such a situation, various studies have been made for maintenance liquids for use in maintenance of ink jet recording apparatuses. For example, JP-A-2013-006294 discloses a maintenance liquid for ink jet recording containing at least water, a compound represented by General Formula (I), 2-pyrrolidone, and a humectant:

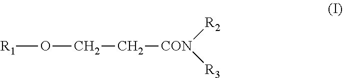

wherein R₁ is a C₁₋₁₀ alkyl group; and R₂ and R₃ are each independently a hydrogen atom or a C₁₋₆ hydrocarbon group that may contain an ether bond and may be the same or different from each other.

However, it has been found that the maintenance liquid described in JP-A-2013-006294 is not sufficient in terms of excellence in the cleaning properties and the anti-clogging properties of ink jet recording apparatuses and the rubbing resistance of recoded products.

### SUMMARY

The present disclosure is an aqueous maintenance liquid for use in maintenance of an ink jet recording apparatus ejecting an ink composition. The ink composition is an aqueous ink composition containing a coloring material. The maintenance liquid contains an organic amine and an organic solvent other than the organic amine. The organic solvent contains Polyol A with a normal boiling point of 250° C. or lower. The content of Polyol A is greater than 20.0% by mass with respect to the total amount of the maintenance liquid. The content of the organic amine is 0.3% by mass or more with respect to the total amount of the maintenance liquid. The total content of the organic solvent is less than 30.0% by mass with respect to the total amount of the maintenance liquid. The organic solvent does not contain Polyol B with a normal boiling point of higher than 250° C. in an amount of greater than 1.0% by mass with respect to the total amount of the maintenance liquid.

### BRIEF DESCRIPTION OF THE DRAWINGS

FIG. 1 is a schematic diagram of a recording apparatus for use in the present embodiment.

FIG. 2 is a table of results of examples.

FIG. 3 is a table of results of examples.

FIG. 4 is a table of results of examples.

FIG. 5 is a schematic diagram of a recording apparatus for use in the present embodiment.

### DESCRIPTION OF EMBODIMENTS

The following describes an embodiment of the present disclosure (hereinafter, referred to as “the present embodiment”) in detail. The present disclosure is not limited to this, and various modifications can be made without departing from the gist thereof.

### 1. Maintenance Liquid

The maintenance liquid according to the present embodiment (hereinafter, also referred to a “maintenance liquid”) is an aqueous maintenance liquid for use in maintenance of an ink jet recording apparatus ejecting an ink composition. The ink composition is an aqueous ink composition containing a coloring material. The maintenance liquid contains an organic amine and an organic solvent other than the organic amine. The organic solvent contains Polyol A with a normal boiling point of 250° C. or lower. The content of Polyol A is greater than 20.0% by mass with respect to the total amount of the maintenance liquid. The content of the organic amine is 0.3% by mass or more with respect to the total amount of the maintenance liquid. The total content of the organic solvent is less than 30.0% by mass with respect to the total amount of the maintenance liquid. The organic solvent does not contain Polyol B with a normal boiling point of higher than 250° C. in an amount of greater than 1.0% by mass with respect to the total amount of the maintenance liquid.

Aqueous ink compositions such as resin inks generally contain resin, and the resin contained in ink compositions can adhere to the inside of an ink jet recording apparatus. Given these circumstances, to perform cleaning or the like of the ink composition remaining inside the ink jet recording apparatus to perform maintenance, an aqueous maintenance liquid is used. In particular, an aqueous maintenance liquid containing an organic solvent is used.

If the content of the organic solvent is high in the maintenance liquid, the viscosity of the maintenance liquid increases, worsening replaceability. For this reason, when the inside of the ink jet recording apparatus is cleaned with the maintenance liquid or the ink composition inside the ink jet recording apparatus is replaced with the maintenance liquid, a large amount of the maintenance liquid is required. In addition, in performing maintenance, when the ink composition inside the ink jet recording apparatus is suctioned and discharged to be cleaned out and then replaced with the maintenance liquid, air bubbles are mixed into the ink jet recording apparatus. Given this, it is desired that the ink composition be directly replaced with the maintenance liquid without emptying the inside of the ink jet recording apparatus. The same applies to a case in which the maintenance liquid is replaced with the ink composition for printing after maintenance. When direct replacement is performed as described above, if the maintenance liquid has high viscosity and bad replaceability, a particularly large amount of the maintenance liquid is required. When the maintenance liquid is replaced with the ink composition, a particularly large amount of the maintenance liquid is required.

When printing is performed after the maintenance of the ink jet recording apparatus, if the maintenance liquid remains inside the ink jet recording apparatus, the organic solvent contained in the maintenance liquid is mixed into the ink composition, which may cause a reduction in the rubbing resistance of a recorded product. In addition, a high content of the organic solvent in the maintenance liquid may adversely affect the environment. To solve the above problems, demanded is reducing the content of the organic solvent in the maintenance liquid.

Meanwhile, depending on the composition of the organic solvent in the maintenance liquid, the maintenance liquid easily evaporates. When such a maintenance liquid is used for maintenance, unfortunately, when a small amount a mixture of the ink composition and the maintenance liquid remains inside the ink jet recording apparatus, the maintenance liquid easily evaporates, and after evaporation, the solid matter of the ink composition dries and solidifies, and even when the maintenance liquid and the ink composition are newly flowed therethrough, it is difficult to remove the solid matter from inside the ink jet recording apparatus, which makes clogging properties inside the ink jet recording apparatus poor.

For example, when the ink composition contains resin, when the organic solvent contained in the maintenance liquid has dissolved the resin contained in the ink composition, the organic solvent evaporates, and after evaporation, the resin solidifies. Even when the maintenance liquid and the ink composition are newly flowed for such solidified resin, it is difficult to remove the solidified resin from inside the ink jet recording apparatus.

In addition, unfortunately, depending on the composition of the organic solvent in the maintenance liquid, when the maintenance liquid remains inside an ink jet head to be mixed with ink, the rubbing resistance of the recorded product is reduced.

Further, depending on the composition of the organic solvent in the maintenance liquid, when the ink jet recording apparatus is filled with the maintenance liquid and is stored for a long term, the maintenance liquid may evaporate to empty the ink jet apparatus. In addition, the freeze resistance, the ink jet ejection properties, the initial ejection properties, and the defoaming agent separation properties of the maintenance liquid may be poor.

Given these circumstances, in the present embodiment, a maintenance liquid containing an organic amine and Polyol A with a normal boiling point of 250° C. or lower in respective certain amounts in combination is used, thereby improving cleaning properties, rubbing resistance, and anti-clogging properties. Anti-clogging properties will be also referred to simply as clogging properties.

The organic amine has high moisture retention properties and can prevent the evaporation of the maintenance liquid by being contained in a small amount. Polyol A with a normal boiling point of 250° C. or lower also has relatively excellent moisture retention properties but does not reduce the rubbing resistance of the recorded product even when it remains inside the ink jet head. Thus, it is considered that the maintenance liquid of the present embodiment is resistant to evaporation while reducing the total content of the organic solvent, and consequently, using this maintenance liquid improves cleaning properties, rubbing resistance, and clogging properties. However, this is not limiting cause of improving cleaning properties, rubbing resistance, and clogging properties.

The surface tension of the maintenance liquid of the present embodiment is preferably 30 mN/m or less, from 15 to 30 mN/m, from 17 to 29 mN/m, and from 20 to 28 mN/m. Further, the surface tension of the maintenance liquid of the present embodiment is preferably from 22 to 26 mN/m.

The surface tension being within the above range tends to improve cleaning properties, rubbing resistance, and clogging properties.

The surface tension of the maintenance liquid can be measured by a surface tension meter, and more specifically, can be measured by the method described in examples.

The following describes the components of the maintenance liquid of the present embodiment each in detail.

### 1.1. Organic Amine

The maintenance liquid of the present embodiment contains an organic amine. The organic amine has high moisture retention properties, and thus the maintenance liquid containing the organic amine in a certain amount tends to improve cleaning properties, rubbing resistance, and clogging properties.

When the maintenance liquid is used for maintenance of the ink jet recording apparatus having an ink jet head, the maintenance liquid may be ejected from the ink jet head to be used for maintenance. By doing so, when the maintenance liquid is desired to be caused to adhere to the inside of the ink jet recording apparatus such as the ink jet head, nozzles, an ink jet head cap, a flushing box, and a flow path for supplying the ink composition, the operation can be performed not manually but by the printer itself, which is preferred. In addition, when an inspection of the nozzles is performed, it can be performed using the maintenance liquid, not the ink composition, which is preferred.

To eject the maintenance liquid from the ink jet head, it is required for the maintenance liquid to have moderate viscosity. However, unfortunately, when the content of the organic solvent is reduced, viscosity is also reduced, and thus during ejection from the ink jet head, faulty ejection such as the occurrence of satellites and the occurrence of curved flight occurs.

The organic amine has moderate viscosity, and thus the maintenance liquid containing the organic amine makes the viscosity of the maintenance liquid in an appropriate range for ejecting it from the ink jet head and can improve ink jet ejection properties even when the content of the organic solvent in the maintenance liquid is reduced, which is preferred.

When the content of the organic solvent is reduced, the maintenance liquid easily evaporates. Unfortunately, when the maintenance liquid evaporates in the nozzles, air bubbles occur inside the nozzles, and consequently, faulty ejection occurs when the maintenance liquid is ejected from the ink jet head.

The organic amine has high moisture retention properties and can prevent the evaporation of the maintenance liquid by being contained in a small amount. Thus, the maintenance liquid containing the organic amine can prevent the maintenance liquid from drying in the nozzles and can improve ink jet ejection properties even when the content of the organic solvent in the maintenance liquid is reduced, which is preferred.

As the organic amine, primary amines, secondary amines, tertiary amines, and the like can be used. Secondary amines or tertiary amines are preferred, and tertiary amines are more preferred. Examples of the organic amine include amines in which the hydrocarbon group bonded to the nitrogen atom of the amine is an aliphatic hydrocarbon group, an aromatic hydrocarbon group, or the like.

Examples of the aliphatic hydrocarbon group bonded to the nitrogen atom of the organic amine include alkyl groups that may be substituted. The alkyl groups preferably have one to five carbon atoms and more preferably have one to three carbon atoms.

The molecule of the organic amine preferably has two to 15 carbon atoms, more preferably has four to 10 carbon atoms, and even more preferably has six to nine carbon atoms. When the organic amine is an alkanolamine, the molecule preferably has one to three hydroxy groups.

Alkanolamines are preferred, in which the aliphatic hydrocarbon group is an alkyl group substituted with a hydroxy group. Examples of the organic amine also include alkylamines, in which the aliphatic hydrocarbon group is an alkyl group not substituted with a hydroxy group. Examples of the organic amine also include heterocyclic amines, in which the nitrogen atom of the organic amine forms a heteroring.

The organic amine is not particularly limited, and examples thereof include alkanolamines (amino alcohols) such as propanolamine, N,N-dimethylpropanolamine, N,N-diethylpropanolamine, isopropanolamine, diisopropanolamine, triisopropanolamine, N,N-dimethylisopropanolamine, N,N-diethylisopropanolamine, monoethanolamine, diethanolamine, triethanolamine, N,N-dimethylethanolamine, N,N-diethylethanolamine, N,N-dibutylethanolamine, N-aminoethylethanolamine, N-methylethanolamine, N-ethylethanolamine, N-butylethanolamine, N-tert-butylethanolamine, N-methyldiethanolamine, N-ethyldiethanolamine, N-butyldiethanolamine, N-tert-butyldiethanolamine, 2-amino-1-propanol, 2-amino-2-methyl-1-propanol, 5-amino-1-pentanol, 2-amino-2-methyl-1,3-propanediol, 2-amino-2-hydroxymethyl-1,3-propanediol, 3-amino-1,2-propanediol, and 3-methylamino-1,2-propanediol.

Examples of the organic amine also include heterocyclic amines such as morpholine, N-methylmorpholine, N-ethylmorpholine, N-(3-aminopropyl)morpholine, N-methylpiperidine, 1,4-dimethylpiperazine, and 1-piperazine ethanol.

Examples of the organic amine also include alkylamines such as triisopropylamine, diisopropylamine, monoisopropylamine, triethylamine, diethylamine, monoethylamine, propylamine, and n-butylamine.

The normal boiling point of the organic amine is preferably 80° C. or higher, more preferably 120° C. or higher, even more preferably 150° C. or higher, still even more preferably 250° C. or higher, and yet still even more preferably 300° C. or higher. The normal boiling point of the organic amine is preferably 350° C. or lower, more preferably 340° C. or lower, and even more preferably 330° C. or lower. The normal boiling point of the organic amine being within the above range makes clogging properties, the rubbing resistance of the recorded product to be obtained, and the like quite excellent, which is preferred.

The water mixed viscosity of the organic amine is preferably 3.0 mPa·s or more, more preferably 3.2 mPa·s or more and 6.0 mPa·s or less, even more preferably 4.0 mPa·s or more and 5.5 mPa·s or less. Further, the water mixed viscosity of the organic amine is preferably 3.5 mPa·s or more and more preferably 3.6 mPa·s or more.

The water mixed viscosity of the organic amine being within the above range or more makes ink jet ejection properties quite excellent. In addition, the rubbing resistance and the image quality of the recorded product to be obtained tend to more improve. The water mixed viscosity of the organic amine being within the above range or less makes cleaning properties and the like quite excellent, which is preferred. The “water mixed viscosity” is the viscosity of a water mixed solution (that is, a 30% by mass aqueous solution) obtained by mixing together 30% by mass of a compound for which the viscosity is measured and 70% by mass of water at 20° C. The viscosity can be measured using, for example, a rotary viscometer. For example, Rheometer (MCR 302 manufactured by Anton Paar) or the like can be used, which is not limiting. The measurement is performed at 20° C. The viscosity can be measured in conformity with, for example, JIS Z8809.

Among them, alkanolamines are preferred, having quite excellent rubbing resistance, ink jet ejection properties, clogging properties, and the like. In addition, they are preferred also in terms of odor and safety. Triisopropanolamine is more preferred. The organic amine may be used singly or used in combination of two or more. The maintenance liquid containing the organic amine tends to improve cleaning properties, rubbing resistance, clogging properties, and ink jet ejection properties.

The content of the organic amine is 0.3% by mass or more and preferably from 0.3 to 10.0% by mass, from 0.3 to 7.5% by mass, from 0.3 to 5.0% by mass, from 0.4 to 4.0% by mass, from 0.5 to 3.0% by mass, from 0.6 to 2.8% by mass, from 0.7 to 2.5% by mass, and from 0.8 to 2.0% by mass with respect the total amount of the maintenance liquid. The content of the organic amine being within the above range tends to improve cleaning properties, rubbing resistance, clogging properties, and ink jet ejection properties.

1.2. Organic Solvent Other than Organic Amine

The maintenance liquid of the present embodiment contains an organic solvent other than the organic amine. The organic solvent other than the organic amine is not particularly limited, and examples thereof include Polyol A with a normal boiling point of 250° C. or lower, Polyol B with a normal boiling point of higher than 250° C., a nitrogen-containing solvent other than the organic amine, and other organic solvents. The organic solvent other than the organic amine may be used singly or used in combination of two or more.

The content of the organic solvent other than the organic amine is less than 30% by mass and preferably greater than 20% by mass and less than 30% by mass, from 21.5 to 29.0% by mass, and from 23.0 to 28.0% by mass with respect to the total amount of the maintenance liquid. The content of the organic solvent other than the organic amine being within the above range tends to improve cleaning properties, rubbing resistance, and clogging properties.

### 1.2.1. Polyols

1.2.1.1 Polyol A with Normal Boiling Point of 250° C. or Lower

The maintenance liquid of the present embodiment contains Polyol A with a normal boiling point of 250° C. or lower. Polyol A has high moisture retention properties, and thus the maintenance liquid containing Polyol A in a certain amount tends to improve cleaning properties, rubbing resistance, and clogging properties. The normal boiling point of Polyol A is preferably from 150 to 250° C., more preferably from 170 to 210° C., and even more preferably from 180 to 200° C.

Containing Polyol A tends to improve the freeze resistance of the maintenance liquid. By improving freeze resistance, even in winter, the maintenance liquid can be filled inside the ink jet recording apparatus including the ink jet head without being frozen, and consequently, the ink jet recording apparatus can be stored without damaging the ink jet head and the like, which is preferred.

Polyol A is a polyol with a normal boiling point of 250° C. or lower among the polyols. The polyols are compounds having two or more hydroxy groups in the molecule. The polyols preferably have two to six hydroxy groups and more preferably have two or three hydroxy groups in the molecule. The polyols are not particularly limited, and examples thereof include alkanepolyols and intermolecular OH condensates of alkanepolyols (polyalkane polyols). Particularly preferred are alkanediols and intermolecular OH condensates of alkanediols (polyalkane diols).

Examples of the alkanediols and the intermolecular OH condensates thereof include alkanediols with two or more carbon atoms and intermolecular OH condensates of the alkanediols. The alkanediols and the alkanediols in the intermolecular OH condensates of the alkanediols preferably have two to eight carbon atoms, more preferably have two to five carbon atoms, and even more preferably have two or three carbon atoms. When the alkanediols are the intermolecular OH condensates of the alkanediols, the number of condensed alkanediols is two or more, preferably two to five, and more preferably two or three.

Examples of the polyols include propylene glycol, hexylene glycol, (2-methyl-2,4-pentanediol), triethylene glycol, ethylene glycol, tetraethylene glycol, pentaethylene glycol, dipropylene glycol, diethylene glycol, 1,3-propanediol, 2-butene-1,4-diol, 2-ethyl-1,3-hexanediol, 2-methyl-1,3-propanediol, neopentyl glycol, 2,2-diethyl-1,3-propanediol, 2-methyl-2-propyl-1,3-propanediol, 1,2-butanediol, 1,3-butanediol, 1,4-butanediol, 1,2-pentanediol, 1,5-pentanediol, 1,2-hexanediol, 1,6-hexanediol, 1,2-octanediol, 3-methyl-1,3-butanediol, 3-methyl-1,5-pentanediol, 4-methyl-1,2-pentanediol, and 2,2,4-trimethyl-1,3-pentanediol. Among these, those with a normal boiling point of 250° C. or lower are examples of Polyol A.

Polyol A is not particularly limited, and examples thereof include ethylene glycol, propylene glycol, trimethylene glycol, pentamethylene glycol, 1,2-butanediol, 2,4-butanediol, 1,2-pentanediol, 2,5-pentanediol, 1,2-hexanediol, and 2,4-hexanediol. Polyol A may be used singly or used in combination of two or more. The maintenance liquid containing Polyol A tends to improve cleaning properties, rubbing resistance, clogging properties, and freeze resistance.

The content of Polyol A is greater than 20% by mass and preferably greater than 20.0% by mass and less than 30.0% by mass, greater than 20.0% by mass and 28.0% by mass or less, from 21.0 to 27.5% by mass, from 22.0 to 27.0% by mass, and from 23.0 to 27.0% by mass with respect to the total amount of the maintenance liquid. Further, the content of Polyol A is from 22.0 to 25.0% by mass. The content of Polyol A being within the above range tends to more improve cleaning properties, rubbing resistance, clogging properties, freeze resistance, and the like.

1.2.1.2. Polyol B with Normal Boiling Point of Higher than 250° C.

When Polyol B with a normal boiling point of higher than 250° C. among the polyols is used for the maintenance liquid, Polyol B has high moisture retention properties, and even when the content of the organic solvent is reduced, the moisture retention properties of the maintenance liquid can be maintained. However, the maintenance liquid remains inside the ink jet head, and when a recorded product is produced thereafter, Polyol B is mixed into the ink composition and reduces the drying properties of the recorded product, which consequently tends to reduce rubbing resistance.

Thus, from the viewpoint of improving rubbing resistance, the content of Polyol B is from 0.0 to 1.0% by mass and preferably from 0.0 to 0.8% by mass, from 0.0 to 0.5% by mass, from 0.0 to 0.2% by mass, and from 0.0 to 0.1% by mass with respect to the total amount of the maintenance liquid. Alternatively, Polyol B is preferably not contained.

Polyol B is not particularly limited, and examples thereof include glycerin, 2,4-toluenediol, 3,4-toluenediol, and biphenyl-2,2′-diol.

1.2.2. Nitrogen-Containing Solvent Other than Organic Amine

The maintenance liquid of the present embodiment may contain the nitrogen-containing solvent other than the organic amine. The nitrogen-containing solvent other than the organic amine is not particularly limited, and preferred examples thereof include amides. Examples thereof also include pyrrolidone-based, imidazolidinone-based, amide ether-based, pyridine-based, pyrazine-based, and pyridone-based ones. Examples of the amides include cyclic amides and non-cyclic amides. More preferred are cyclic amides, especially pyrrolidone-based ones, and examples thereof include 2-pyrrolidone, N-methyl-2-pyrrolidone, and N-ethyl-2-pyrrolidone. The nitrogen-containing solvent may be used singly or used in combination of two or more. The maintenance liquid containing the nitrogen-containing solvent other than the organic amine tends to improve cleaning properties, rubbing resistance, and clogging properties.

The content of the nitrogen-containing solvent other than the organic amine is preferably 1.0% by mass or more, 2.0% by mass or more, and 3.0% by mass or more with respect to the total amount of the maintenance liquid. The content of the nitrogen-containing solvent other than the organic amine is preferably from 1.0 to 10.0% by mass, from 2.0 to 9.0% by mass, from 3.0 to 8.0% by mass, and from 3.0 to 7.0% by mass. The content of the nitrogen-containing solvent other than the organic amine being within the above range tends to improve cleaning properties, rubbing resistance, and clogging properties.

### 1.2.3. Other Organic Solvents

The maintenance liquid of the present embodiment may contain the other organic solvents other than the above. The other organic solvents are not particularly limited, and examples thereof include monools, glycol ethers, and sulfur-containing solvents. The other organic solvents may be used singly or used in combination of two or more.

### 1.3. Surfactant

The maintenance liquid of the present embodiment may further contain a surfactant. The surfactant is not particularly limited, and examples thereof include acetylene glycol-based surfactants, fluorine-based surfactants, and silicone-based surfactants. The surfactant may be used singly or used in combination of two or more.

The acetylene glycol-based surfactants are not particularly limited, and examples thereof include 2,4,7,9-tetramethyl-5-decyne-4,7-diol and alkylene oxide adducts of 2,4,7,9-tetramethyl-5-decyne-4,7-diol and 2,4-dimethyl-5-decyn-4-ol and alkylene oxide adducts of 2,4-dimethyl-5-decyn-4-ol. Commercially available products of the acetylene glycol-based surfactants are not particularly limited, and examples thereof include the Olfine 104 series and the E series such as Olfine E1010 (manufactured by Nissin Chemical Co., Ltd.) and Surfynol 61 (manufactured by Evonik Industries AG). The acetylene glycol-based surfactants may be used singly or used in combination of two or more.

The fluorine-based surfactants are not particularly limited, and examples thereof include perfluoroalkyl sulfonates, perfluoroalkyl carbonates, perfluoroalkyl phosphates, perfluoroalkyl ethylene oxide adducts, perfluoroalkyl betaines, and perfluoroalkyl amine oxide compounds. Commercially available products of the fluorine-based surfactants are not particularly limited, and examples thereof include S-144 and S-145 (manufactured by Asahi Glass Co., Ltd.); FC-170C, FC-430, and Fluorad-FC4430 (manufactured by Sumitomo 3M Ltd.); FSO, FSO-100, FSN, FSN-100, and FS-300 (manufactured by DuPont); and FT-250 and 251 (manufactured by Neos Company Limited). The fluorine-based surfactants may be used singly or used in combination of two or more.

The silicone-based surfactants are not particularly limited, and examples thereof include polysiloxane-based compounds and polyether-modified organosiloxanes. Commercially available products of the silicone-based surfactant are not particularly limited, and specific examples thereof include BYK-306, BYK-307, BYK-333, BYK-341, BYK-345, BYK-346, BYK-347, BYK-348, and BYK-349 (manufactured by BYK-Chemie Japan K.K.) and KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (manufactured by Shin-Etsu Chemical Co., Ltd.). The silicone-based surfactants may be used singly or used in combination of two or more.

The content of the surfactant is preferably from 0.1 to 5.0% by mass, from 0.1 to 2.5% by mass, from 0.1 to 1.0% by mass, from 0.2 to 0.8% by mass, and from 0.3 to 0.5% by mass with respect to the total amount of the maintenance liquid.

### 1.4. Defoaming Agent

The maintenance liquid of the present embodiment may contain a defoaming agent. The maintenance liquid containing the defoaming agent prevents air bubbles from being generated in the maintenance liquid. Thus, when the maintenance liquid is filled in the ink jet recording apparatus, and then the first ejection is performed, the ratio of nozzles not performing ejection tends to decrease, and initial ejection properties tend to be excellent.

Meanwhile, unfortunately, when the content of the organic solvent in the maintenance liquid is reduced, when the maintenance liquid contains the defoaming agent, the defoaming agent separates.

Given these circumstances, the maintenance liquid containing Polyol A tends to prevent the defoaming agent from separating from the maintenance liquid and to improve defoaming agent separation properties even when the content of the organic solvent in the maintenance liquid is reduced.

The defoaming agent is not particularly limited, and examples thereof include silicone-based defoaming agents, polyether-based defoaming agents, fatty acid ester-based defoaming agents, and acetylene glycol-based defoaming agents. Examples of commercially available products of the defoaming agent include BYK-011, BYK-012, BYK-017, BYK-018, BYK-019, BYK-020, BYK-021, BYK-022, BYK-023, BYK-024, BYK-025, BYK-028, BYK-038, BYK-044, BYK-080A, BYK-094, BYK-1610, BYK-1615, BYK-1650, BYK-1730, and BYK-1770 (manufactured by BYK-Chemie Japan K.K.) and Surfynol DF37, DF110D, DF58, DF75, DF220, and MD-20 and EnviroGem AD01 (manufactured by Evonik Industries AG). The defoaming agent may be used singly or used in combination of two or more. The maintenance liquid containing the defoaming agent tends to make initial ejection properties excellent.

The content of the defoaming agent is not particularly limited with respect to the total amount of the maintenance liquid, and examples thereof include from 0.0 to 1.0% by mass, from 0.0 to 0.5% by mass, from 0.0 to 0.4% by mass, and from 0.0 to 0.3% by mass. Further, the content of the defoaming agent is preferably from 0.0 to 0.1% by mass and more preferably from 0.0 to 0.05% by mass.

### 1.5. Water

Water contained in the maintenance liquid of the present embodiment is not particularly limited, and examples thereof include ion exchanged water, ultrafiltered water, reverse osmosis water, distilled water, and pure water.

The maintenance liquid is an aqueous maintenance liquid. The aqueous means containing at least water as a main component as solvent components contained in a composition. The content of water is preferably 50% by mass or more with respect to the total amount of the maintenance liquid. Further, the content of water is preferably 60.0% by mass or more and less than 80.0% by mass, from 65.0 to 78.0% by mass, and from 70.0 to 75.0% by mass.

### 1.6. Other Components

The maintenance liquid of the present embodiment may contain other known components that can be used for maintenance liquids in the related art in addition to the above components. The other components are not particularly limited, and examples thereof include dissolution aids, viscosity adjusting agents, pH adjusting agents, antioxidants, antiseptics, anticorrosive agents, chelating agents for capturing certain metal ions having influence on dispersion, other additives, aqueous low-molecular weight organic compounds other than the above, and organic compounds other than the aqueous low-molecular weight organic compounds. The other components may be used singly or used in combination of two or more.

### 2. Ink Composition

The ink composition of the present embodiment (hereinafter, also referred to as an “ink composition”) is an aqueous ink composition containing a coloring material. The surface tension of the ink composition is preferably 30 mN/m or less, from 15 to 30 mN/m, from 17 to 29 mN/m, and from 20 to 28 mN/m.

The surface tension of the ink composition can be measured by a surface tension meter, and more specifically, can be measured by the method in the examples.

The following describes the components of the ink composition of the present embodiment each in detail.

### 2.1. Coloring Material

The coloring material is not particularly limited, and examples thereof include disperse dyes and pigments. The coloring material may be used singly or used in combination of two or more.

The disperse dyes are not particularly limited, and examples thereof include known ones such as C.I. Disperse Yellow, C.I. Disperse Orange, C.I. Disperse Blue, C.I. Disperse Violet, and C.I. Disperse Black. The disperse dyes may be used singly or used in combination of two or more.

Inorganic pigments are not particularly limited, and examples thereof include carbon blacks (C.I. Pigment Black 7) such as furnace black, lamp black, acetylene black, and channel black, iron oxide, and titanium oxide. The inorganic pigments may be used singly or used in combination of two or more.

Organic pigments are not particularly limited, and examples thereof include quinacridone-based pigments, quinacridonequinone-based pigments, dioxazine-based pigments, phthalocyanine-based pigments, anthrapyrimidine-based pigments, anthanthrone-based pigments, indanthrone-based pigments, flavanthrone-based pigments, perylene-based pigments, diketopyrrolopyrrole-based pigments, perinone-based pigments, quinophthalone-based pigments, anthraquinone-based pigments, thioindigo-based pigments, benzimidazolone-based pigments, isoindolinone-based pigments, azomethine-based pigments, and azo-based pigments. The organic pigments may be used singly or used in combination of two or more.

The content of the coloring material is preferably from 0.5 to 20.0% by mass, from 0.7 to 15.0% by mass, and from 1.0 to 10.0% by mass with respect to the total amount of the ink composition.

### 2.2. Resin

The ink composition of the present embodiment may contain a resin. Examples of the resin include ones dissolved in the ink composition and ones dispersed in the form of resin particles, emulsions, or the like. Using such a resin tends to make the rubbing resistance of the recorded product excellent.

Such a resin is not particularly limited, and examples thereof include polyolefin resins, acrylic resins, vinyl acetate resins, vinyl chloride resins, butadiene resins, styrene resins, polyester resins, cross-linked acrylic resins, cross-linked styrene resins, benzoguanamine resins, phenolic resins, silicone resins, epoxy resins, urethane resins, paraffin resins, fluorine resins, water-soluble resins, and copolymers obtained by combining monomers forming these resins. As the resin, polymer latexes containing these resins can be used.

Examples of the polymer latexes include polymer latexes containing fine particles of polyolefin resins, acrylic resins, styrene resins, cross-linked acrylic resins, and cross-linked styrene resins. The resin may be used singly or used in combination of two or more.

The acrylic resins are polymers obtained by polymerizing at least acrylic monomers and also include copolymerized polymers of the acrylic monomers and other monomers. Examples of the acrylic monomers include (meth)acrylate and (meth)acrylic acid. Examples of the other monomers include a vinyl monomer, and examples thereof styrene. Examples of the acrylic resins include styrene-acrylic resins.

The urethane resins are resins obtained by urethane polymerization of a polyisocyanate compound and a polyol compound.

Among the resins, preferred are acrylic resins, urethane resins, polyolefin resins, and polyester resins. More preferred are acrylic resins and urethane resins.

The content of the resin is preferably from 0.5 to 20.0% by mass, from 1.0 to 15.0% by mass, from 2.0 to 12.5% by mass, and from 3.0 to 10.0% by mass with respect to the total amount of the ink composition. The content of the resin being within the above range tends to make the rubbing resistance of the recorded product excellent.

### 2.3. Organic Amine

The ink composition of the present embodiment may contain an organic amine. As in the maintenance liquid, using the organic amine tends to improve rubbing resistance, clogging properties, and ink jet ejection properties while reducing the content of an organic solvent in the ink composition.

The organic amine is not particularly limited, and those exemplified in the maintenance liquid can be used, for example. The content of the organic amine is preferably from 0.3 to 10.0% by mass, from 0.3 to 7.5% by mass, from 0.3 to 5.0% by mass, from 0.4 to 4.0% by mass, from 0.5 to 3.0% by mass, from 0.6 to 2.8% by mass, from 0.7 to 2.5% by mass, and from 0.8 to 2.0% by mass with respect the total amount of the ink composition

2.4. Organic Solvent Other than Organic Amine

The ink composition of the present embodiment may contain an organic solvent other than the organic amine. The organic solvent other than the organic amine is not particularly limited, and examples thereof include Polyol A with a normal boiling point of 250° C. or lower, Polyol B with a normal boiling point of higher than 250° C., a nitrogen-containing solvent other than the organic amine, and other organic solvents. The organic solvent other than the organic amine may be used singly or used in combination of two or more.

The content of the organic solvent other than the organic amine is preferably from 10.0 to 45.0% by mass, from 12.5 to 40.0% by mass, from 15.0 to 37.5% by mass, and from 16.0 to 35.0% by mass with respect to the total amount of the ink composition. The content of the organic solvent other than the organic amine being within the above range tends to improve rubbing resistance and clogging properties.

### 2.4.1. Polyols

2.4.1.1. Polyol A with Normal Boiling Point of 250° C. or Lower

The ink composition of the present embodiment may contain Polyol A with a normal boiling point of 250° C. or lower. As in the maintenance liquid, using Polyol A tends to improve rubbing resistance, clogging properties, and freeze resistance while reducing the content of the organic solvent in the ink composition.

Polyol A is not particularly limited, and those exemplified in the maintenance liquid can be used, for example. The content of Polyol A is preferably from 10.0 to 40.0% by mass, from 12.5 to 38.0% by mass, and from 15.0 to 36.0% by mass with respect to the total amount of the ink composition.

2.4.1.2. Polyol B with Normal Boiling Point of Higher than 250° C.

Using Polyol B with a normal boiling point of higher than 250° C. for the ink composition reduces the drying properties of the recorded product, which consequently tends to reduce rubbing resistance.

Thus, from the viewpoint of improving rubbing resistance, the content of Polyol B is from 0.0 to 1.0% by mass and preferably from 0.0 to 0.8% by mass, from 0.0 to 0.5% by mass, from 0.0 to 0.2% by mass, and from 0.0 to 0.1% by mass with respect to the total amount of the ink composition. Alternatively, Polyol B is preferably not contained. Polyol B is not particularly limited, and examples thereof include those described in the maintenance liquid.

When the ink composition containing Polyol B in a large amount is used, even when the maintenance liquid of the present embodiment is used, the rubbing resistance of the recorded product is reduced. For example, when rubbing resistance is evaluated by the method described in the examples described below using the maintenance liquid of the present embodiment and the ink composition containing Polyol B in an amount of 5% by mass with respect to the total amount of the ink composition, a result corresponding to a grade of C is obtained.

Meanwhile, when clogging properties and cleaning properties are evaluated by the methods described in the examples described below using the maintenance liquid of the present embodiment and the ink composition containing Polyol B in an amount of 5% by mass with respect to the total amount of the ink composition, results corresponding to a grade of A for both are obtained.

2.4.2. Nitrogen-Containing Solvent Other than Organic Amine

The ink composition of the present embodiment may contain a nitrogen-containing solvent other than the organic amine. The nitrogen-containing solvent other than the organic amine is not particularly limited, and those exemplified in the maintenance liquid can be used, for example. The content of the nitrogen-containing solvent other than the organic amine is preferably 1.0% by mass or more, 2.0% by mass or more, and 3.0% by mass or more with respect to the total amount of the ink composition. Further, the content of the nitrogen-containing solvent other than the organic amine is preferably from 1.0 to 10.0% by mass, from 2.0 to 9.0% by mass, from 3.0 to 8.0% by mass, and from 3.0 to 7.0% by mass.

### 2.4.3. Other Organic Solvents

The ink composition of the present embodiment may contain other organic solvents other than the above. The other organic solvents are not particularly limited, and those exemplified in the maintenance liquid can be used, for example.

### 2.5. Surfactant

The ink composition of the present embodiment may contain a surfactant. The surfactant is not particularly limited, and those exemplified in the maintenance liquid can be used, for example. The content of the surfactant is preferably from 0.1 to 5.0% by mass, from 0.1 to 2.5% by mass, from 0.1 to 1.0% by mass, from 0.2 to 0.8% by mass, and from 0.3 to 0.5% by mass with respect to the total amount of the ink composition.

### 2.6. Defoaming Agent

The ink composition of the present embodiment may contain a defoaming agent. As in the maintenance liquid, using the defoaming agent tends to make initial ejection properties excellent.

Meanwhile, unfortunately, when the content of the organic solvent in the ink composition is reduced, when the ink composition contains the defoaming agent, the defoaming agent separates.

Given these circumstances, the ink composition containing Polyol A tends to prevent the defoaming agent from separating from the ink composition and to improve defoaming agent separation properties even when the content of the organic solvent in the ink composition is reduced.

The defoaming agent is not particularly limited, and those exemplified in the maintenance liquid can be used, for example. The content of the defoaming agent is not particularly limited with respect to the total amount of the ink composition, and examples thereof include from 0.0 to 1.0% by mass, from 0.0 to 0.5% by mass, from 0.0 to 0.4% by mass, and from 0.0 to 0.3% by mass.

### 2.7. Water

Water contained in the ink composition of the present embodiment is not particularly limited, and examples thereof include ion exchanged water, ultrafiltered water, reverse osmosis water, distilled water, and pure water.

The content of water is preferably 45.0% by mass or more with respect to the total amount of the ink composition. Further, the content of water is from 45.0 to 98.0% by mass, from 45.0 to 80.0% by mass, from 47.5 to 77.5% by mass, and from 50.0 to 75.0% by mass.

### 2.8. Other Components

The ink composition of the present embodiment may contain other known components that can be used for ink compositions in the related art in addition to the above components. The other components are not particularly limited, and examples thereof include dissolution aids, viscosity adjusting agents, pH adjusting agents, antioxidants, antiseptics, anticorrosive agents, chelating agents for capturing certain metal ions having influence on dispersion, other additives, aqueous low-molecular weight organic compounds other than the above, and organic compounds other than the aqueous low-molecular weight organic compounds. The other components may be used singly or used in combination of two or more.

### 3. Recording Medium

A recording medium for use in recording of the ink composition of the present embodiment is not particularly limited, and examples thereof include absorbent recording media, low-absorbent recording media, and non-absorbent recording media.

The absorbent recording media are not particularly limited, and examples thereof include plain papers such as papers for electrophotography or the like having high ink permeability, ink jet papers (ink jet dedicated papers including an ink absorbing layer containing silica particles or alumina particles or an ink absorbing layer containing a hydrophilic polymer such as polyvinyl alcohol (PVA) or polyvinylpyrrolidone (PVP), and fabrics.

The low-absorbent recording media are not particularly limited, and examples thereof include art papers, coated papers, and cast papers for use in general offset printing having relatively low ink permeability.

The non-absorbent recording media are not particularly limited, and examples thereof include films and plates made of plastics such as polyvinyl chloride, polyethylene, polypropylene, polyethylene terephthalate (PET), polycarbonate, polystyrene, and polyurethane; plates made of metals such as iron, silver, copper, and aluminum; metal plates produced by depositing these various kinds of metals, plastic films, and plates made of alloys such as stainless and brass; and recording media obtained by bonding (applying) films made of plastics such as polyvinyl chloride, polyethylene, polypropylene, polyethylene terephthalate (PET), polycarbonate, polystyrene, and polyurethane to base materials made of paper.

In the case of the low-absorbent recording media and the non-absorbent recording media, it is particularly important to enable recording of the recorded product having excellent rubbing resistance and water resistance; the ink of the present embodiment is particularly useful in that it has excellent rubbing resistance and the like of the recorded product.

### 4. Method of Ink Jet Recording

The method of ink jet recording using the ink composition of the present embodiment includes an ink adhesion step of ejecting the ink composition of the present embodiment from the ink jet head and causing the ink composition to adhere to the recording medium. The method of ink jet recording using the ink composition of the present embodiment may include other steps such as a transportation step of transporting the recording medium as needed.

### 4.1. Ink Adhesion Step

In the ink adhesion step, the ink composition of the present embodiment is ejected from the ink jet head to be caused to adhere to the recording medium. More specifically, pressure generating means provided inside the ink jet head is driven to eject the ink composition filled inside a pressure generating chamber of the ink jet head from the nozzles.

Examples of the ink jet head for use in the ink adhesion step include a line head performing recording by a line system and a serial head performing recording by a serial system.

In the line system using the line head, for example, the ink jet head having a width of a recording width of the recording medium or more is fixed to a recording apparatus. The recording medium is moved in a sub-scanning direction (a direction of transporting the recording medium), and along with this movement, ink droplets are ejected from the nozzles of the ink jet head to record images on the recording medium.

In the serial system using the serial head, for example, the ink jet head is installed in a carriage that can move in the width direction of the recording medium. The carriage is moved in a main scanning direction (the width direction of the recording medium), and along with this movement, ink droplets are ejected from the nozzles of the ink jet head to record images on the recording medium.

### 4.2. Transportation Step

The method of ink jet recording using the ink composition of the present embodiment may include the transportation step. In the transportation step, the recording medium is transported in a certain direction inside the recording apparatus. More specifically, the recording medium is transported from a paper feeder to a paper discharger of the recording apparatus using transportation rollers and/or transportation belts provided inside the recording apparatus. In the transportation step, the ink composition ejected from the ink jet head adheres to the recording medium to form the recorded product. The ink adhesion step and the transportation step may be simultaneously performed or alternately performed.

### 5. Method of Maintenance

The method of maintenance of the present embodiment has a maintenance step, may have a refilling step, and may have other steps as needed.

### 5.1. Maintenance Step

In the maintenance step of the present embodiment, maintenance of the ink jet recording apparatus ejecting the ink composition is performed using the maintenance liquid. The maintenance referred to here is not particularly limited, and examples thereof include cleaning the ink composition adhering to the inside of the ink jet recording apparatus such as the ink jet head, the nozzles, the ink jet head cap, the flushing box, and the flow path for supplying the ink composition with the maintenance liquid and filling the inside of the ink jet head with the maintenance liquid.

Examples of the maintenance also include filling the maintenance liquid inside the ink jet head in order to perform transportation, dispatch, suspension, inspection, and the like of the ink jet recording apparatus with the maintenance liquid filled in the ink jet head.

Having the maintenance step of filling the maintenance liquid inside the ink jet head tends to improve the clogging properties of the recording apparatus.

In the maintenance step, for example, the maintenance liquid may be ejected from the ink jet head to be used for maintenance of the ink jet recording apparatus having the ink jet head, although this operation is not particularly limiting. By doing so, when the maintenance liquid is desired to be caused to adhere to the inside of the ink jet recording apparatus such as the ink jet head, the nozzles, the ink jet head cap, the flushing box, and the flow path for supplying the ink composition, the operation can be performed not manually but by the printer itself, which is preferred. When a clogging inspection of the nozzles is performed, performing the inspection using the maintenance liquid, not the ink composition, is also preferred.

In such a case also, the maintenance liquid of the present embodiment has excellent ejection properties from the ink jet head, which is preferred.

The maintenance liquid contains the organic amine in a certain amount and thus has viscosity within an appropriate range for performing ejection from the ink jet head while the content of the organic solvent is reduced. Thus, the maintenance liquid can be ejected from the ink jet head to be used for maintenance.

In the maintenance step of the present embodiment, the maintenance liquid may be filled inside the ink jet recording apparatus. This can prevent adherents caused by the ink composition from remaining inside the ink jet recording apparatus when the ink jet recording apparatus is not used for a long term or is transported. In addition, the inside of the ink jet recording apparatus can be prevented from drying, and the ink jet head and the like can be prevented from deteriorating. In addition, the maintenance liquid may be used as liquid to be ejected when the ink jet head is inspected.

### 5.2. Refilling Step

In the refilling step of the present embodiment, after the maintenance step, the ink composition is refilled in the ink jet head and the flow path. Having the refilling step can quickly form the recorded product without bringing about a reduction in image quality caused by nozzle omissions or the like.

### 6. Recording Apparatus

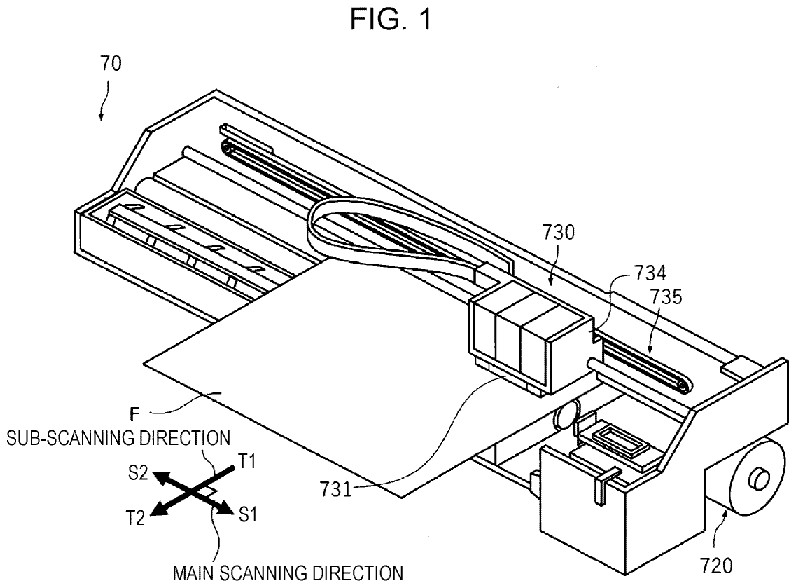

FIG. 1 illustrates a perspective view of a serial printer as an example of the ink jet recording apparatus. As illustrated in FIG. 1, this serial printer 70 includes a transporting section 720 and a recording section 730. The transporting section 720 transports a recording medium F fed to the serial printer to the recording section and discharges the recording medium after recording to the outside of the serial printer. Specifically, the transporting section has feeding rollers and transports the fed recording medium F in a sub-scanning direction T2.

The recording section includes a carriage 734 installed with an ink jet head 731 having nozzles ejecting the ink composition to the recording medium F fed from the transporting section and a carriage moving mechanism 735 moving the carriage in a main scanning direction S1 and S2 of the recording medium F.

The serial printer includes a head of a length smaller than the width of the recording medium as the ink jet head, and the head moves to perform recording on a plurality of passes. In the serial printer, the head is installed in a carriage moving in a certain direction. The head moves along with the movement of the carriage to eject the ink composition onto the recording medium F. This performs recording on two passes or more. Note that the pass is also referred to as main scanning. Sub-scanning transporting the recording medium is performed between passes. That is, the main scanning and the sub-scanning are alternately performed.

The ink jet recording apparatus of the present embodiment is not limited to the printer of the serial system but may be a printer of the line system. The printer of the line system is a printer performing recording on single scanning onto the recording medium using a line head as an ink jet head having a length of the recording width of the recording medium or more.

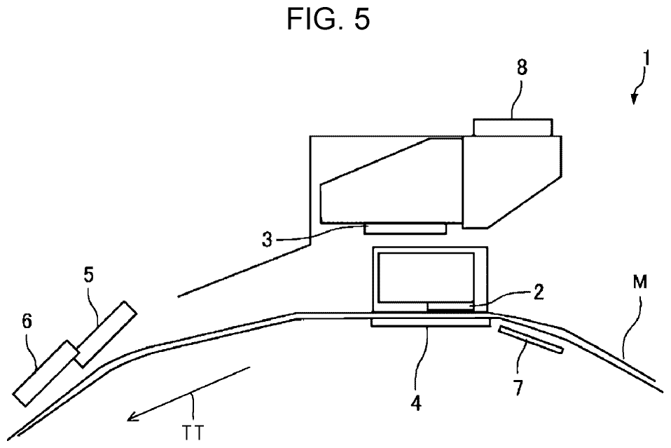

FIG. 5 is a schematic side view schematically illustrating an example of the surroundings of the ink jet head and a recording medium transporting path of the ink jet recording apparatus. This drawing corresponds to a side view of the ink jet recording apparatus in FIG. 1 viewed from the main scanning direction. This ink jet recording apparatus 1 performs recording onto a recording medium M by this ink jet head 2. The recording medium M is transported in the sub-scanning direction TT along the recording medium transporting path supporting the recording medium from below.

The ink jet head 2 may be for the printer of the serial type, in which it moves in the main scanning direction, which is the far-to-near direction in FIG. 5. Alternatively, the printer may be the printer of the line type, in which the ink jet head is the line head extending in the width direction of the recording medium, which is the fart-to-near direction in FIG. 5.

In the example in FIG. 5, the ink jet recording apparatus includes an IR heater 3, a platen heater 4, a heating heater 5, a cooling fan 6, a preheater 7, and a blowing fan 8.

### Primary Drying Mechanism

The ink jet recording apparatus 1 can include a primary drying mechanism drying the recording medium M when the ink is ejected from the ink jet head 2 to be caused to adhere to the recording medium. The primary drying mechanism can include a conductive type, a blowing type, a radiation type, or the like. The conductive type conducts heat from a member in contact with the recording medium to the recording medium. Examples thereof include the platen heater 4 and the preheater 7. The blowing type sends normal temperature wind or hot wind to the recording medium to dry the ink and the like. Examples thereof include the blowing fan 8. The radiation type radiates radiation generating heat to the recording medium to heat the recording medium. Examples thereof include the IR heater 3. Although not illustrated in the drawing, a heater similar to the platen heater may be provided immediately downstream of the platen heater 4 in the TT direction. These primary drying mechanisms may be used singly or used in combination. As the primary drying mechanism, drying by heating is preferred.

In the ink adhesion step, drying performed by the primary drying mechanism is referred to as a primary drying step. When the method of recording includes the primary drying step, the ink that has adhered to the recording medium is dried in an early stage to make image quality excellent, which is preferred. Meanwhile, the ink jet head and the recording apparatus therearound receive heat from the primary drying mechanism, and the ink easily dries and solidifies. Even in such a case, using the maintenance liquid of the present embodiment can perform excellent maintenance, which is preferred. The surface temperature of the recording medium subjected to the primary drying step is preferably from 20 to 50° C., more preferably from 30 to 45° C., and even more preferably from 35 to 40° C. The temperature may be the surface temperature of the recording medium during ink adhesion.

### Secondary Drying Mechanism

After the ink adhesion step, a secondary drying step may be included heating the recording medium by a secondary drying mechanism to further dry and fix the ink. The step is also referred to as a later-drying step.

The heating heater 5 for use in the secondary drying mechanism dries and solidifies the ink that has adhered to recording medium M. The heating heater 5 heats the recording medium M on which images have been recorded, and thereby water and the like contained in the ink evaporate and scatter more quickly, forming an ink film by the resin contained in the ink. Thus, the ink film is firmly fixed or bonded to the recording medium M to make film forming properties excellent, and excellent high-quality images can be obtained in a short time. In the secondary drying step, the maintenance liquid of the present embodiment is preferably used in that it provides quite excellent rubbing resistance.

The surface temperature of the recording medium subjected to the secondary drying step is preferably from 50 to 100° C., more preferably from 60 to 90° C., and even more preferably 70 to 80° C.

The ink jet recording apparatus 1 may have the cooling fan 6. After drying the ink recorded on the recording medium M, the ink on the recording medium M is cooled by the cooling fan 6, and thereby the ink film can be formed on the recording medium M with good adhesion.

### Examples

The following describes the present disclosure more specifically using examples and comparative examples. The present disclosure is not limited by the following examples at all. Unless otherwise specified, the operations were performed at room temperature (25° C.) and 10⁵ Pa.

### 1. Preparation of Maintenance Liquid

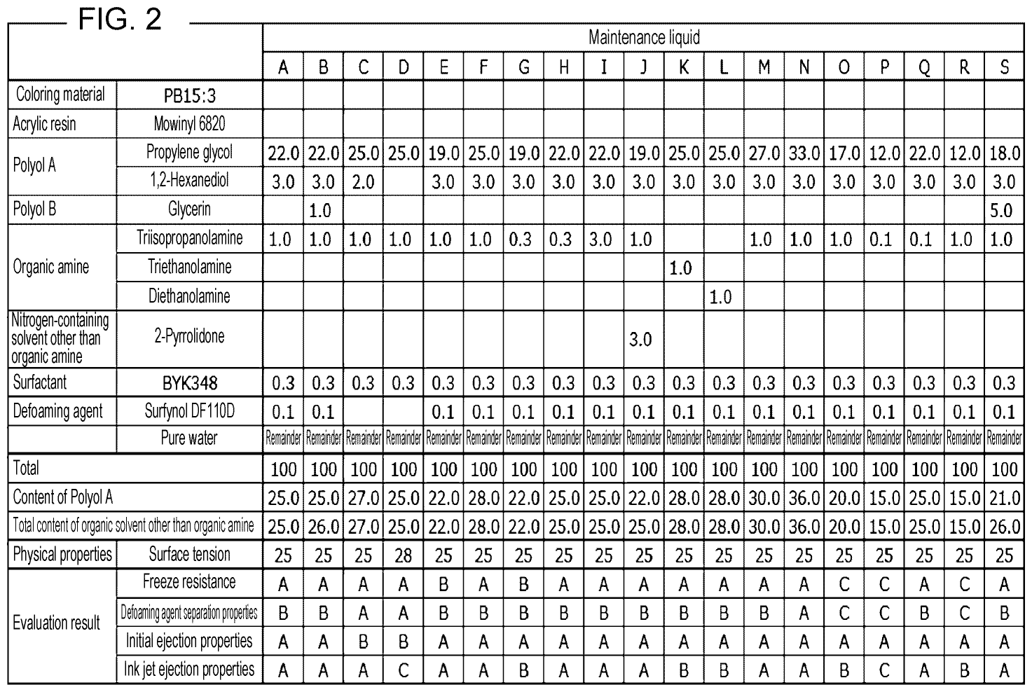

Components were put into a tank for mixture so as to be the compositions listed in FIG. 2 and were mixed and stirred to obtain maintenance liquids of the examples and the comparative examples. The values of the components shown in the examples in the drawing are represented in % by mass unless otherwise specified. The surface tension was measured by the plate method using a platinum plate.

The materials listed in FIG. 2 are as follow:
Surfactant
BYK-348 (manufactured by BYK-Chemie Japan K.K.)
Defoaming agent
Surfynol DF110D (manufactured by Evonik Industries AG)
Organic amine
Triisopropanolamine (normal boiling point: 301° C., water mixed viscosity: 4.8 mPa·s)
Triethanolamine (normal boiling point: 335° C., water mixed viscosity: 3.5 mPa·s)
Diethanolamine (normal boiling point: 268° C., water mixed viscosity: 3.8 mPa·s)
Polyols
Propylene glycol (normal boiling point: 188° C.)
1,2-Hexanediol (normal boiling point: 224° C.)
Glycerin (normal boiling point: 290° C.)

### 2. Preparation of Ink Composition

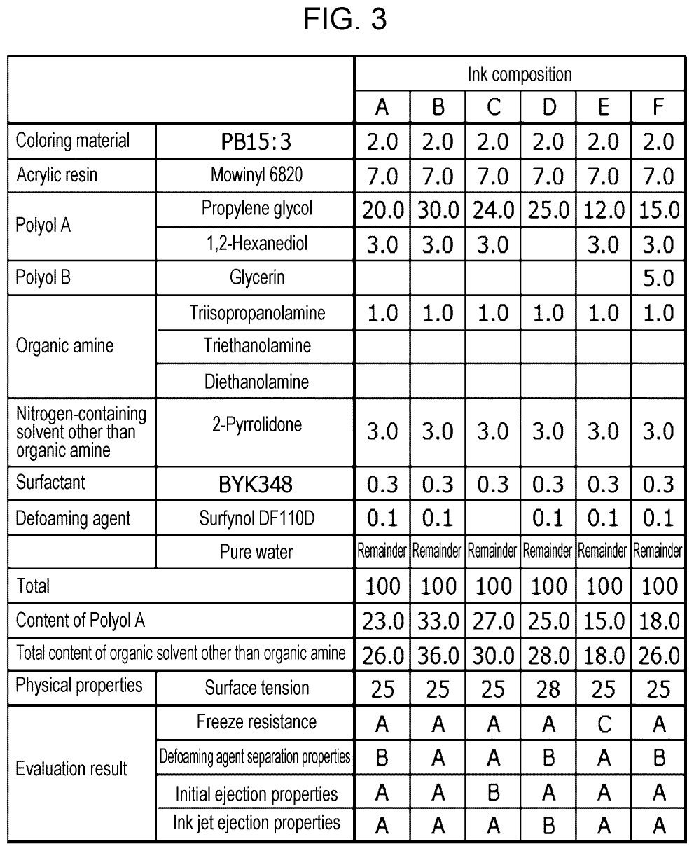

Components were put into a tank for mixture so as to be the compositions listed in FIG. 3 and were mixed and stirred to obtain ink compositions of the examples and the comparative examples. The values of the components shown in the examples in the drawing are represented in % by mass unless otherwise specified. Those of solids such as the pigment are in % by mass of the solids. As to the pigment, a pigment dispersant (an aqueous acrylic resin) not listed in the table was mixed in water with a mass ratio of pigment:pigment dispersant=4:1, and the mixture was stirred to prepare a pigment dispersion in advance, which was used for ink preparation.

The materials listed in FIG. 3 are as follows:
Coloring material
PB15:3 (phthalocyanine-based pigment, Pigment Blue 15:3)
Acrylic resin
Mowinyl 6820 (manufactured by Japan Coating Resin Co., Ltd., resin particles)
Surfactant
BYK-348 (manufactured by BYK-Chemie Japan K.K.)
Defoaming agent
Surfynol DF110D (manufactured by Evonik Industries AG)

### 3. Evaluation

### 3.1. Freeze Resistance

Each of the maintenance liquids of the examples and the comparative examples and each of the ink compositions of the examples and the comparative examples were put into a 5 cc container, which was lidded and stored in a freezer. The presence or absence of freezing was then checked and evaluated.

### Criteria

A: There is no freezing at −10° C.

B: There is freezing at −10° C., but there is no freezing at −5° C.

C: There is freezing at −5° C.

### 3.2. Defoaming Agent Separation Properties

Each of the maintenance liquids of the examples and the comparative examples and each of the ink compositions of the examples and the comparative examples in an amount of 20 g were put into a 30 mL screw tube, which was left in a 60° C. thermostat oven and a 70° C. thermostat oven for 21 days. It was taken out and naturally cooled to room temperature (25° C.). The presence or absence of the separation of the defoaming agent was then visually checked and evaluated.

### Criteria

A: There is no separation even when left at 70° C. for 21 days.

B: There is separation when left at 70° C. for 21 days, but there is no separation when left at 60° C. for 21 days.

C: There is separation when left at 70° C. for 21 days, and there is separation when left at 60° C. for 21 days.

### 3.3. Initial Ejection Properties

A modified machine of SC-R5050 manufactured by Seiko Epson Corporation was prepared. With an ink jet head having 360 nozzles and a supply path leading to the ink jet head emptied, each of the maintenance liquids of the examples and the comparative examples and each of the ink compositions of the examples and the comparative examples were filled in the ink jet head through the supply path. Subsequently, the maintenance liquid in an amount of 10 cc per ink jet head from the nozzles of the ink jet head was discharged, and in that state, the nozzles were inspected and evaluated. Note that when air bubbles are generated during filling, a non-ejecting nozzle, in which the maintenance liquid and the ink composition are not ejected, appears.

### Criteria

A: The number of non-ejecting nozzles is 1% or less of all the nozzles.

B: The number of non-ejecting nozzles is greater than 1% of all the nozzles.

### 3.4. Ink Jet Ejection Properties

A modified machine of SC-R5050 manufactured by Seiko Epson Corporation was prepared. The maintenance liquid or the ink composition was filled in the head. Head suction cleaning was sufficiently performed to make a state in which all the nozzles perform ejection. In this state, the ejection state of each of the maintenance liquids of the examples and the comparative examples and each of the ink compositions of the examples and the comparative examples from the nozzles was observed with an ultrahigh-speed camera and evaluated. Note that when the maintenance liquid and the ink composition are difficult to stably eject, satellites occur or curved flight occurs, hindering regular ejection. Examples of such a case include a case of low viscosity due to a too high content of water or the like and a case of relatively high surface tension.

### Criteria

A: There are neither satellites nor curved flight.

B: There are satellites, but there is no curved flight.

C: There are satellites, and there is also curved flight.

### 3.5. Clogging Properties

A modified machine of SC-R5050 manufactured by Seiko Epson Corporation was prepared. With each of the ink compositions of the examples and the comparative examples filled in the ink jet head, suction cleaning was performed to discharge the ink composition inside the ink jet head, emptying the ink jet head. Next, each of the maintenance liquids of the examples and the comparative examples was filled in the ink jet head, and then suction cleaning was performed to discharge the maintenance liquid inside the ink jet head, emptying the ink jet head. The ink jet head in this state was left at 60° C. for 1 day. Next, the ink composition was filled in the ink jet head, 50 cc of the ink composition was ejected from the ink jet head, and the nozzles were inspected and evaluated. Even after the ink composition and the maintenance liquid were discharged, small amounts of the ink composition and the maintenance liquid remained inside the ink jet head, and the influence of drying and solidifying of the residue after being left on clogging was checked.

### Criteria

A: There are no non-ejecting nozzles.

B: The number of non-ejecting nozzles is 2% or less of all the nozzles.

C: The number of non-ejecting nozzles is greater than 2% of all the nozzles.

### 3.6. Rubbing Resistance

A modified machine of SC-R5050 manufactured by Seiko Epson Corporation was prepared. With each of the maintenance liquids of the examples and the comparative examples filled in the ink jet head, suction cleaning was performed to discharge the maintenance liquid inside the ink jet head, emptying the ink jet head, and then each of the ink compositions of the examples and the comparative examples was supplied. In this state, a test pattern (an ink composition adhering amount: 7 mg/inch²) was printed on a recording medium PET 50A (manufactured by Lintec Corporation) and was subjected to secondary drying by the secondary drying mechanism (the heating heater) with a surface temperature of the recording medium of 60° C. for 5 minutes to form a recorded product having a recorded section.

When this recorded product was rubbed by a Gakushin type rubbing resistance testing machine (load: 500 g) 50 times using plain-woven cloth wetted with water, the degree of peeling of the recorded section was visually evaluated.

### Criteria

A: There is no peeling, and there is no or almost no transcription to the cloth.

B: There is peeling in 10% or less of the recorded section.

C: There is peeling in greater than 10% of the recorded section.

### 3.7. Cleaning Properties

A modified machine of SC-R5050 manufactured by Seiko Epson Corporation was prepared. With each of the ink compositions of the examples and the comparative examples filled in an ink jet head and a supply path leading to the ink jet head, each of the maintenance liquids of the examples and the comparative examples was supplied from upstream of the supply path toward the ink jet head to perform suction cleaning. It was then observed that the ink composition as the liquid discharged from the ink jet head was gradually replaced with the maintenance liquid. The degree of this replacement was checked by measuring the absorbance of the discharged liquid to evaluate cleaning properties. Specifically, cleaning properties were evaluated by the volume of the maintenance liquid supplied until the absorbance of the discharged liquid at 600 nm decreased to 10% of the absorbance of the ink composition at 600 nm.

### Criteria

A: The maintenance liquid in an amount of 500 mL or less is required.

B: The maintenance liquid in an amount of greater than 500 mL and 700 mL or less is required.

C: The maintenance liquid in an amount of greater than 700 mL is required.

### 4. Evaluation Results

It was found from the evaluation results in FIGS. 2 to 4 that all Examples 1 to 16 were superior to Comparative Examples 1 and 2, in which the total content of the organic solvent other than the organic amine was high, Comparative Examples 3, 4, and 6, in which the content of Polyol A was low, Comparative Examples 4 and 5, in which the content of the organic amine was low, and Comparative Example 7, in which the content of Polyol B was high in all of clogging properties, rubbing resistance, and cleaning properties. Further, Examples 1 to 16 were good also in freeze resistance, defoaming agent separation properties, initial ejection properties, and ink jet ejection properties.

On the other hand, Comparative Examples 1 to 7 were inferior in any of clogging properties, rubbing resistance, and cleaning properties.

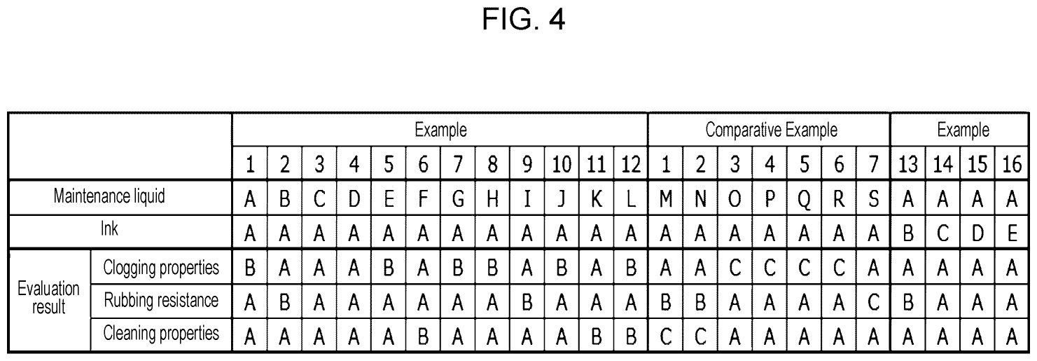

Although not shown in FIG. 4, when evaluation was performed in the same manner with the ink in Example 1 changed to F, it showed a grade of A in clogging properties and cleaning properties but showed a grade of C in rubbing resistance. It is inferred that this is caused by the ink composition.

What is claimed is:

1. An aqueous maintenance liquid for use in maintenance of an ink jet recording apparatus ejecting an ink composition, wherein
the ink composition is an aqueous ink composition containing a coloring material,
the maintenance liquid contains:
an organic amine; and
an organic solvent other than the organic amine,
the organic solvent contains Polyol A with a normal boiling point of 250° C. or lower,
a content of Polyol A is greater than 20.0% by mass with respect to a total amount of the maintenance liquid,
a content of the organic amine is 0.3% by mass or more with respect to the total amount of the maintenance liquid,
a total content of the organic solvent is less than 30.0% by mass with respect to the total amount of the maintenance liquid, and
the organic solvent does not contain Polyol B with a normal boiling point of higher than 250° C. in an amount of greater than 1.0% by mass with respect to the total amount of the maintenance liquid.

2. The maintenance liquid according to claim 1, wherein the content of the organic amine is from 0.3 to 5.0% by mass with respect to the total amount of the maintenance liquid.

3. The maintenance liquid according to claim 1, wherein the content of Polyol A is greater than 20.0% by mass and 28.0% by mass or less with respect to the total amount of the maintenance liquid.

4. The maintenance liquid according to claim 1, wherein the ink composition does not contain, as the organic solvent, Polyol B with a normal boiling point of higher than 250° C. in an amount of greater than 1% by mass with respect to a total amount of the ink composition.

5. The maintenance liquid according to claim 1, wherein
surface tension of the maintenance liquid is 30 mN/m or less, and
the maintenance liquid does not contain a defoaming agent in an amount of greater than 0.3% by mass with respect to the total amount of the maintenance liquid.

6. The maintenance liquid according to claim 1, wherein
surface tension of the ink composition is 30 mN/m or less, and
the ink composition does not contain a defoaming agent in an amount of greater than 0.4% by mass with respect to a total amount of the ink composition.

7. The maintenance liquid according to claim 1, wherein the organic amine contains an alkanolamine.

8. The maintenance liquid according to claim 1, wherein the ink composition contains a nitrogen-containing solvent other than the organic amine in an amount of 3.0% by mass or more.

9. The maintenance liquid according to claim 1, wherein
the ink jet recording apparatus has an ink jet head, and
the maintenance liquid is ejected from the ink jet head to be used for maintenance.

10. A method of maintenance comprising a maintenance step of performing maintenance of an ink jet recording apparatus ejecting an ink composition using an aqueous maintenance liquid, wherein
the ink composition is an aqueous ink composition containing a coloring material, and
the maintenance liquid is the maintenance liquid according to claim 1.
